(19) United States
(12) Patent Application Publication
(10) Pub. No.: US 2018/0066588 A1
(43) Pub. Date: Mar. 8, 2018

(54) FUEL FLOW SYSTEM

(71) Applicant: ROLLS-ROYCE plc, London (GB)

(72) Inventors: James H. DALY, Birmingham (GB); Marko BACIC, Oxford (GB)

(73) Assignee: ROLLS-ROYCE plc, London (GB)

(21) Appl. No.: 15/683,409

(22) Filed: Aug. 22, 2017

(30) Foreign Application Priority Data
Sep. 5, 2016 (GB) 1614987.4

(51) Int. Cl. F02C 7/228

(52) U.S. Cl. CPC F02C 7/228; F02C 7/222

(57) ABSTRACT

A fuel flow system comprising a fuel manifold and a fuel nozzle. A fluidic valve having an inlet, a first outlet and a control flow inlet. The inlet is coupled to the fuel manifold. The first outlet is coupled to the fuel nozzle. The control flow inlet is coupled to a source of control fuel. The fluidic valve is configured to selectively couple the inlet to the first outlet dependent on the control flow into the control flow inlet.

The present disclosure concerns a fuel flow system, particularly a fuel flow system for a gas turbine engine. The fuel flow system may be a staged fuel system.

In a gas turbine engine fuel flow system there is typically a fuel manifold and a plurality of fuel nozzles which atomise fuel into the combustion chamber where it is ignited. The fuel is supplied to the fuel nozzles from the fuel manifold.

In a staged combustion fuel system there are two sets of nozzles, pilot and mains, which deliver fuel into the combustion chamber for ignition. At low power engine conditions only the pilot nozzles are supplied with fuel, typically via a pilot manifold. At higher power engine conditions the mains nozzles are also supplied with fuel from a mains manifold. In pilot-only mode it is necessary to tightly seal the mains nozzles from the fuel to prevent fuel entering the combustor. It is also preferred to maintain fuel flow in the mains manifold and close to the mains nozzles to prevent stagnant fuel from coking in the pipes due to the high temperature environment. To meet the requirements to seal the mains nozzles from the fuel but also to keep fuel flowing in the pipes it is usual to provide a spring-based valve close to the head of each nozzle. The valve may, for example, be opened by fluid pressure against the spring reaching a predetermined crack pressure.

One disadvantage of such valves is that the springs may become degraded through age and the operational environment. Consequently the valves may stop sealing completely causing some fuel leakage into the combustor. The springs may also break or jam so that a valve fails in the open position. This results in a hot streak in the combustor where fuel is supplied through a mains nozzle at only one circumferential position. Mitigation actions tend to sacrifice the benefits of staged combustion in order to stabilise the combustion, for example because all mains nozzle valves are opened to equalise the fuel delivery circumferentially.

According to a first aspect of the present invention there is provided a fuel flow system comprising:
a fuel manifold;
a fuel nozzle; and
a fluidic valve having an inlet, a first outlet and a control flow inlet; the inlet coupled to the fuel manifold; the first outlet coupled to the fuel nozzle; and the control flow inlet coupled to a source of control fuel; the fluidic valve configured to selectively couple the inlet to the first outlet dependent on the control flow into the control flow inlet.

Advantageously the fluidic valve has no moving parts and so is more reliable in a high temperature environment. Advantageously the fuel flow system is therefore suitable for a gas turbine engine. Advantageously the fluidic valve can be positioned close to the combustion chamber where the environment is hot.

The system may further comprise a plurality of fuel nozzles. The first outlet of the fluidic valve may be coupled to each of the plurality of fuel nozzles. The system may also comprise a plurality of fluidic valves. The first outlet of each fluidic valve may be coupled to one or more of the plurality of fuel nozzles. Advantageously flow to more than one nozzle can be controlled from one fluidic valve.

The system may comprise two or more fluidic valves, the first output of one of the fluidic valves coupled to the flow control inlet of a second of the fluidic valves. Advantageously by cascading fluidic valves in this manner the volume of inlet flow which can be diverted is amplified. Advantageously the range of mains manifold flow rates which can be controlled by the fluidic valve cascade is large, for example 30 pounds per hour to 1400 pounds per hour.

The fluidic valve may comprise any one of: a fluidic diverter; a linear proportional amplified; a vortex amplifier; a turbulence amplifier. Alternatively the fluidic valve may have a different form. Advantageously the most appropriate fluidic valve may be chosen for the specific application contemplated.

The system may further comprise fuel split apparatus arranged to selectively couple the fuel manifold to a fuel source. The fuel split apparatus may comprise a splitter valve. Alternatively the fuel split apparatus may comprise a control valve having two outputs. Advantageously the fluidic valve can be run without fuel. Advantageously the fluidic valve can be operated with air (or another gas) instead of fuel in order to purge the inlet and outlet passages of fuel droplets. Advantageously this reduces the risk of coking when the fluidic valve is positioned in a hot environment.

The source of control fuel may comprise the fuel manifold. Advantageously the volume of outlet flow is equal to the volume of flow taken from the fuel manifold so it can be precisely quantified and controlled,

The fuel flow system may comprise mains and pilot fuel stages wherein the fuel manifold is a mains manifold and the fuel nozzle is a pilot nozzle. Advantageously the system is suitable for controlling staged combustion, Advantageously in pilot-only mode fuel can be delivered through the mains manifold to cool its pipes but be delivered into the combustor through the pilot nozzle or nozzles.

A pilot manifold may be coupled to the pilot fuel nozzle. The system may comprise fuel split apparatus arranged to selectively couple the pilot manifold to the fuel source.

The mains manifold and the pilot manifold may each be coupled to the fuel source. Alternatively the mains manifold and the pilot manifold may each be coupled to different fuel sources.

The mains manifold may be selectively coupled to the pilot manifold when the fluidic valve inlet is coupled to the first outlet. Advantageously the flow to the inlet of the fluidic valve may therefore be drawn from the pilot manifold via the mains manifold. Advantageously it is easier to accurately meter the fuel flow.

The system may further comprise a mains nozzle selectively coupled to the mains manifold. The fluidic valve may comprise a second outlet coupled to the mains nozzle. Advantageously in a first operating configuration the fuel is delivered to the pilot nozzle and in a second operating configuration the fuel is delivered to the mains nozzle.

The present invention also provides a gas turbine engine comprising a fuel flow system as described,

The skilled person will appreciate that except where mutually exclusive, a feature described in relation to any one of the above aspects may be applied mutatis mutandis to any other aspect. Furthermore except where mutually exclusive any feature described herein may be applied to any aspect and/or combined with any other feature described herein.

Embodiments will now be described by way of example only, with reference to the Figures, in which:

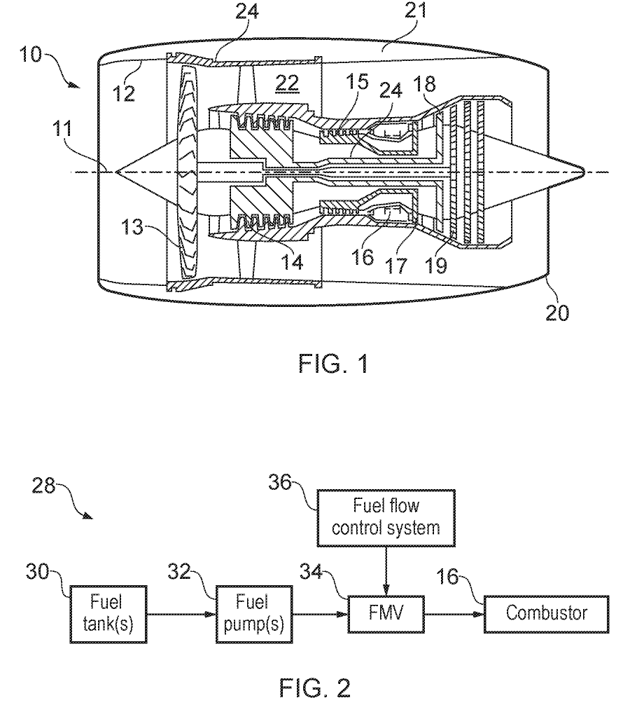

FIG. 1 is a sectional side view of a gas turbine engine;

FIG. 2 is a flow chart of a fuel flow system;

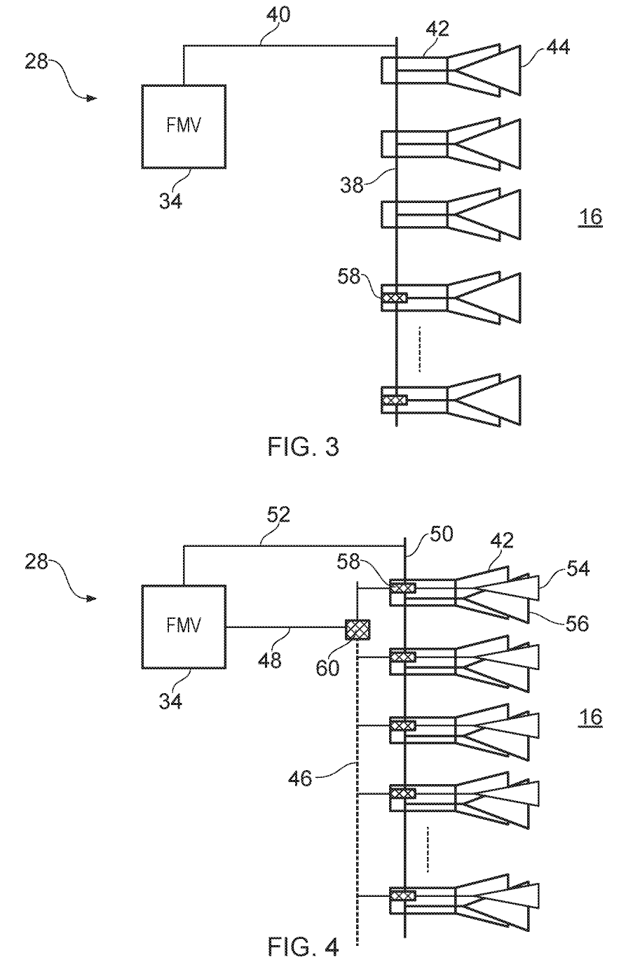

FIG. 3 is a schematic view of a fuel flow system;

FIG. 4 is a schematic view of a two-stage fuel flow system;

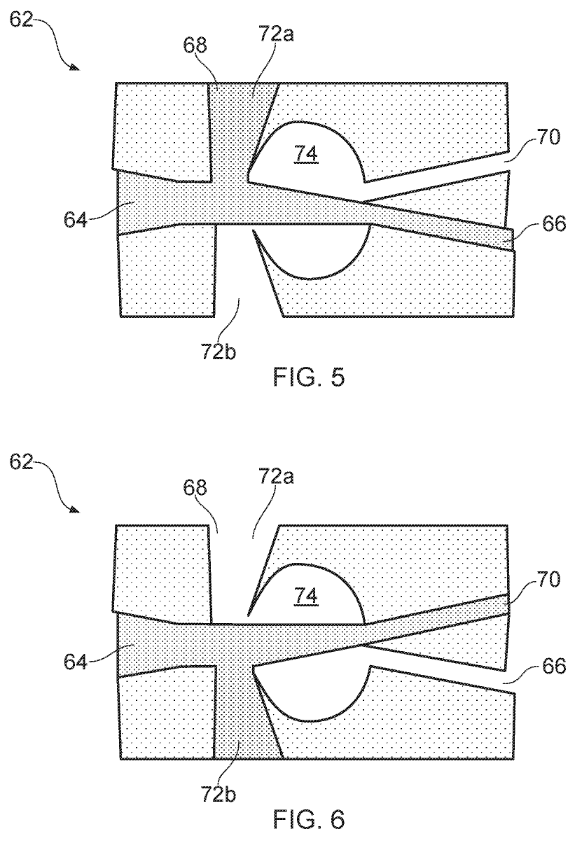

FIG. 5 is a schematic illustration of a fluidic valve, in a first configuration, for use in the fuel flow system;

FIG. 6 is a schematic illustration of a fluidic valve, in a second configuration, for use in the fuel flow system;

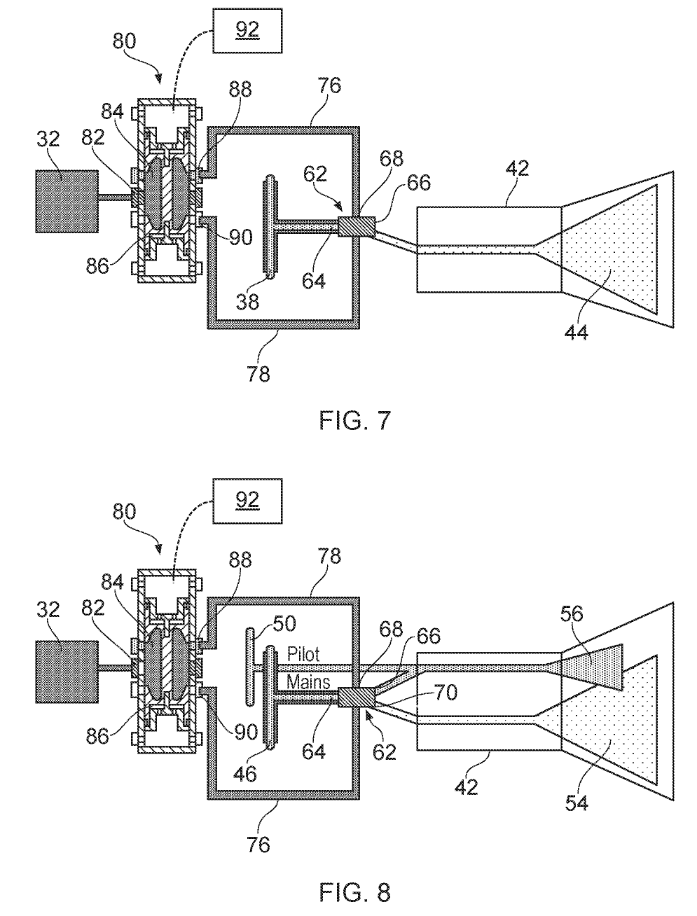

FIG. 7 is a schematic view of part of the fuel flow system;

FIG. 8 is a schematic view of part of the two-stage fuel flow system;

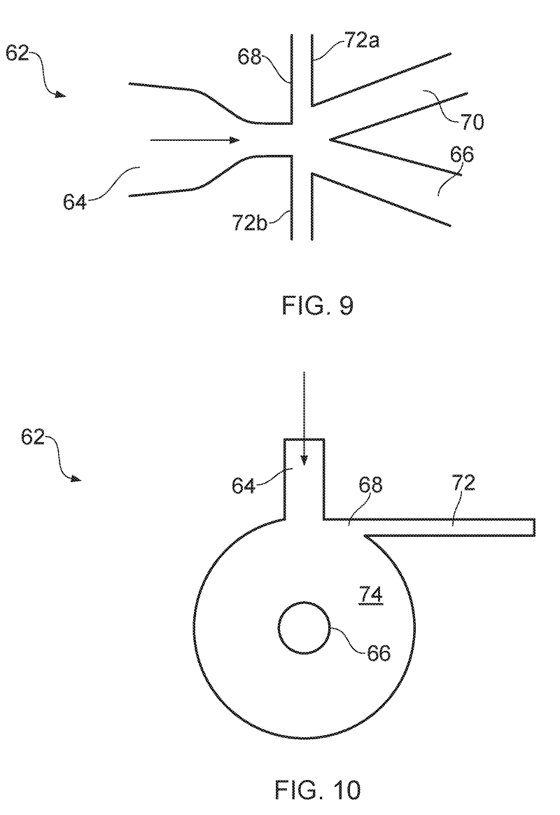

FIG. 9 is a schematic view of another fluidic valve for use in the fuel flow system;

FIG. 10 is a schematic view of another fluidic valve for use in the fuel flow system;

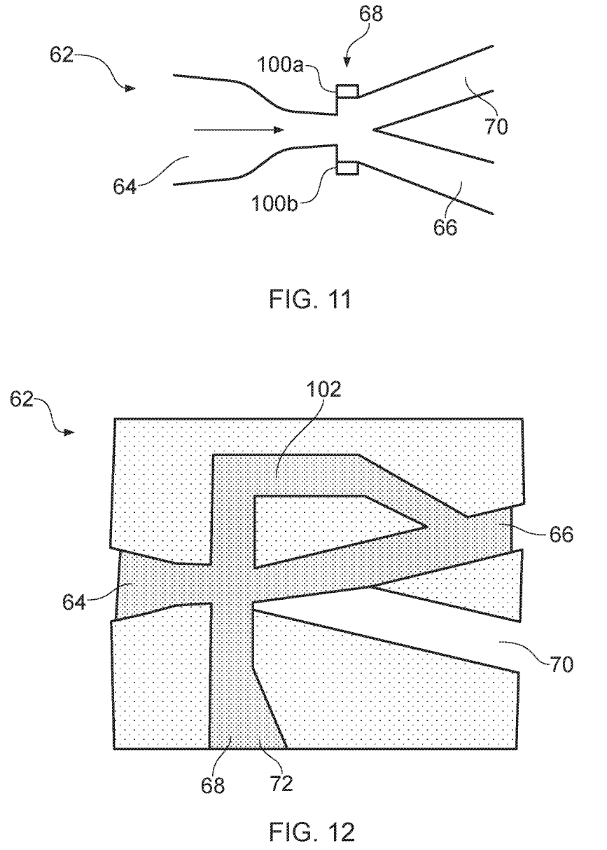

FIG. 11 is a schematic view of another fluidic valve for use in the fuel flow system;

FIG. 12 is a schematic view of another fluidic valve for use in the fuel flow system in a first operating configuration;

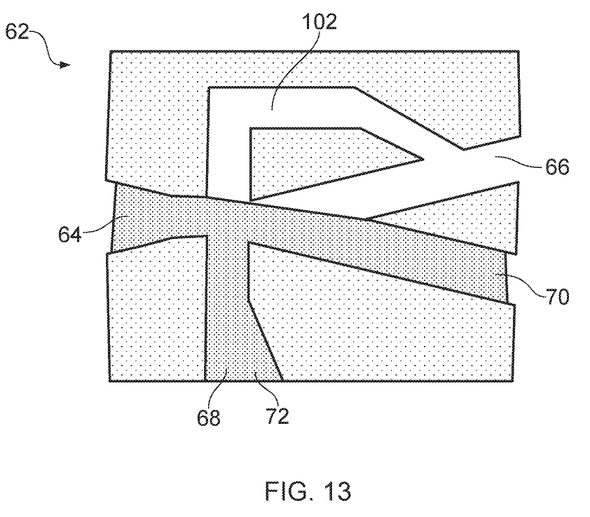

FIG. 13 is a schematic view of another fluidic valve for use in the fuel flow system in a second operating configuration;

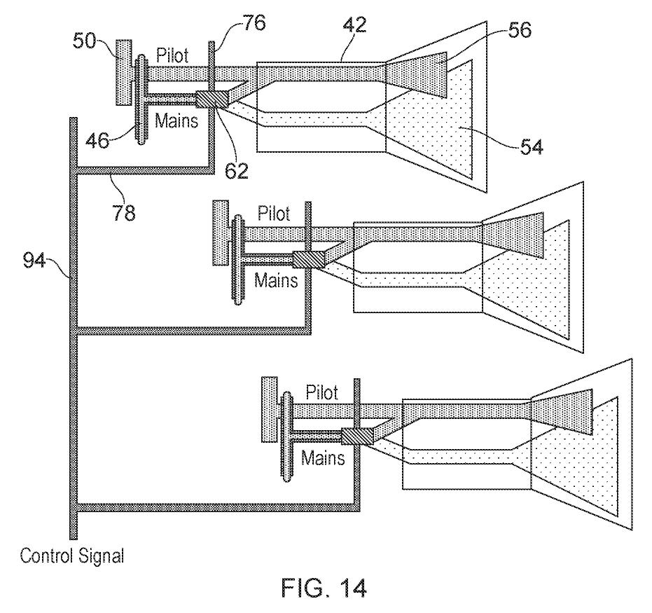

FIG. 14 is a schematic view of part of the fuel flow system;

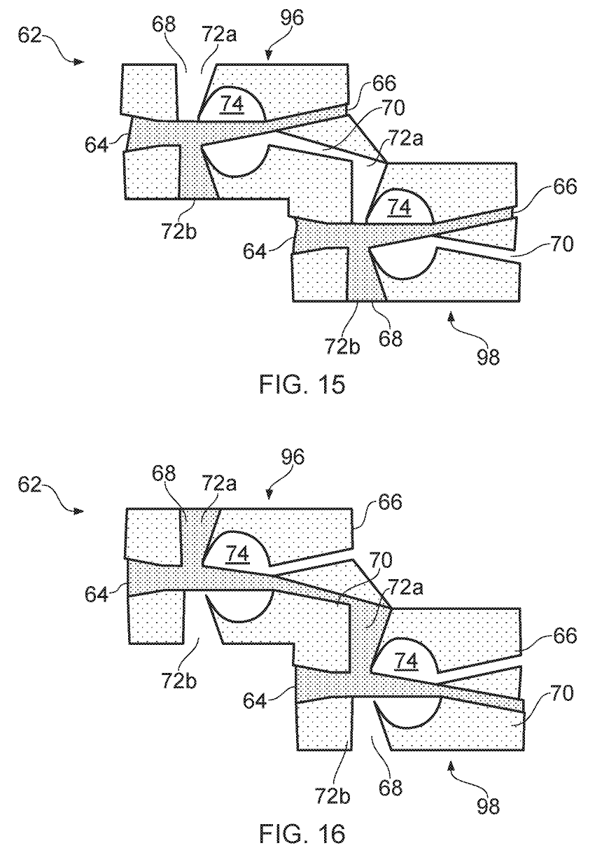

FIG. 15 is a schematic illustration of a fluidic valve cascade, in a first configuration, for use in the fuel flow system;

FIG. 16 is a schematic illustration of a fluidic valve cascade, in a second configuration, for use in the fuel flow system.

With reference to FIG. 1, a gas turbine engine is generally indicated at 10, having a principal and rotational axis 11. The engine 10 comprises, in axial flow series, an air intake 12, a propulsive fan 13, an intermediate pressure compressor 14, a high-pressure compressor 15, combustion equipment 16, a high-pressure turbine 17, an intermediate pressure turbine 18, a low-pressure turbine 19 and an exhaust nozzle 20. A nacelle 21 generally surrounds the engine 10 and defines both the intake 12 and the exhaust nozzle 20.

The gas turbine engine 10 works in the conventional manner so that air entering the intake 12 is accelerated by the fan 13 to produce two air flows: a first air flow into the intermediate pressure compressor 14 and a second air flow which passes through a bypass duct 22 to provide propulsive thrust. The intermediate pressure compressor 14 compresses the air flow directed into it before delivering that air to the high pressure compressor 15 where further compression takes place.

The compressed air exhausted from the high-pressure compressor 15 is directed into the combustion equipment 16 where it is mixed with fuel and the mixture combusted. The resultant hot combustion products then expand through, and thereby drive the high, intermediate and low-pressure turbines 17, 18, 19 before being exhausted through the nozzle 20 to provide additional propulsive thrust. The high 17, intermediate 18 and low 19 pressure turbines drive respectively the high pressure compressor 15, intermediate pressure compressor 14 and fan 13, each by suitable interconnecting shaft.

Other gas turbine engines to which the present disclosure may be applied may have alternative configurations. By way of example such engines may have an alternative number of interconnecting shafts (e.g. two) and/or an alternative number of compressors and/or turbines. Further the engine may comprise a gearbox provided in the drive train from a turbine to a compressor and/or fan.

A fuel flow system 28 is illustrated schematically in FIG. 2. Fuel is supplied to the gas turbine engine 10 from one or more fuel tanks 30, for example located in the aircraft body or wings where the gas turbine engine 10 powers an aircraft. The fuel may be pressurised through one or more pumps 32 and delivered to a fuel metering valve 34. The fuel metering valve 34 is controlled by a fuel flow control system 36 which implements methods of controlling the fuel flow in the gas turbine engine 10. The fuel metering valve 34 delivers the demanded fuel flow to the combustor 16, via one or more sets of fuel nozzles.

FIG. 3 shows part of the fuel flow system 28 in more detail. The fuel metering valve 34 delivers fuel to a fuel manifold 38 via a supply pipe 40. The fuel manifold 38 may be annular or may be partially annular. It may be fed by one or more than one supply pipe 40 at circumferentially spaced intervals. There may be a return pipe (not shown) to return unburnt fuel from the fuel manifold 38 to a cooler part of the fuel system, for example to the fuel pumps 32 or tanks 30. The fuel flow system 28 also includes a plurality of fuel injectors 42. Each injector 42 includes a fuel nozzle 44 which is configured to receive fuel from the fuel manifold 38, to atomise the fuel and to deliver it into the combustor 16 to be mixed with air and ignited. One or more of the injectors 42 may include a valve 58. The valve 58 is arranged to permit or block fuel flow from the manifold 38 to the nozzle 44. The valve 58 may be a fluidic valve 58 as described below with respect to FIG. 5 and FIG. 6, FIG. 9 or FIG. 10.

FIG. 4 is similar to FIG. 3 but shows a staged fuel flow system 28. The fuel metering valve 34 delivers fuel to a mains manifold 46 via mains supply pipe 48 and also delivers fuel to a pilot manifold 50 via pilot supply pipe 52. There may be a return pipe (not shown) from each manifold 46, 50 to return unburnt fuel to the fuel pumps 32, tanks 30 or another cooler part of the fuel system. There may also be a return pipe to return unburnt fuel from the mains manifold 46 into the pilot manifold 50.

Each injector 42 houses a mains nozzle 54 and a pilot nozzle 56. The mains nozzles 54 are fed with fuel from the mains manifold 46. The pilot nozzles 56 are fed from the pilot manifold 50. The fuel metering valve 34 is arranged to meter the desired proportion of the fuel to the mains nozzles 54 and the pilot nozzles 56 as determined by the fuel flow control system 36. In low power phases of engine operation the pilot nozzles 54 are fed with fuel from the pilot manifold 50 and no fuel is delivered to the combustor 16 through the mains nozzles 56. In higher power phases of engine operation fuel is delivered through the pilot nozzles 54 as before but more fuel is delivered to the combustor 16 through the mains nozzles 56. A valve 58 is provided to selectively couple each mains nozzle 54 to the mains manifold 46. Alternatively a valve 60 may be provided that controls whether fuel is supplied to all or a subset of the mains nozzles 54,

In some staged combustion fuel systems there may be more than one mains stage in which some mains nozzles 56 are supplied with fuel during a first pilot+mains 1 phase and more of the mains nozzles 56 are fuelled in a pilot+mains 1+mains 2 phase of operation. In other staged combustion fuel systems there may be a subset of the pilot nozzles 54 which are fuelled from a first pilot manifold 50 with the remainder of the pilot nozzles 54 fuelled from a second pilot manifold 50. This enables preferential fuelling of a subset of the pilot nozzles 54 to maintain combustion during transient engine operation.

FIG. 5 and FIG. 6 each show a fluidic valve 62, particularly a linear proportional amplifier, to control flow between the mains manifold 46 and the mains nozzles 54 for the multiple manifold fuel flow system 28 shown in FIG. 4. The fluidic valve 62 is also suitable to control flow between the fuel manifold 38 and fuel nozzles 44 for the single manifold fuel flow system 28 shown in FIG. 3 and references to the mains manifold 46 and mains nozzles 54 should be understood to alternatively cover the fuel manifold 38 and fuel nozzles 44. Such a fluidic valve 62 can be used as either valve 58 or valve 60 as shown in FIG. 4. A linear proportional amplifier may be suitable for inlet flows having a Reynolds number of less than approximately 2000.

The fluidic valve 62 includes an inlet 64. The inlet 64 is coupled to the mains manifold 46 to receive fuel flowing therethrough. The fluidic valve 62 includes a first outlet 66. The first outlet 66 is coupled to one or more of the pilot nozzles 56 in the injectors 42 (or to one or more of the fuel nozzles 44). The fluidic valve 62 also includes a control flow inlet 68 which is coupled to a source of control fluid. The source of control fluid may be the mains manifold 46. Alternatively it may be a different source. Preferably the control fluid is fuel because it is mixed with the flow that enters the fluidic valve 62 through the inlet 64. The control flow inlet 68 may be arranged to receive approximately 10% of the total flow through the fluidic valve 62, which is sufficient to affect the output direction of the remaining 90% of the flow.

Optionally the fluidic valve 62 includes a second outlet 70. The second outlet 70, where provided, may be coupled to one or more of the mains nozzles 54. In the single manifold fuel flow system 28 the second outlet 70, where provided, may be coupled to the fuel manifold 38 or to a return pipe so that the fuel is circulated around the fuel flow system 28 instead of stagnating. Optionally the control flow inlet 68 comprises two ports 72a, 72b which are each coupled to the source of control fluid. The control fluid is supplied to one or other of the ports 72a, 72b of the control flow inlet 68 to switch the flow out of the fluidic valve 62. Since the fluidic valve 62 is a linear proportional amplifier a proportion of the control fluid may be supplied to each of the ports 72a, 72b at the same time. In this case the inlet flow is split in the equivalent proportions between the first and second outlets 66, 70 so that the flow out of the fluidic valve 62 is modulated.

The fluidic valve 62 also optionally includes a chamber 74 between the inlet 64 and the first outlet 66. The chamber 74 gives space for the inlet jet to swing between the first and second outlets 66, 70. There may be some fluid recirculation in the chamber 74. The chamber 74 may optionally include a vent (not shown) to prevent pressure discrepancies between the first and second outlets 66, 70 causing fluid to be pulled from the intended outlet and entrained into the other outlet. It is noted that a larger chamber 74 results in a slower response of the fluidic valve 62.

FIG. 5 shows the fluidic valve 62 in a first configuration in which the control fluid is delivered through the first port 72a of the control flow inlet 68. The control fluid may be provided from the mains manifold 46 or from the pilot manifold 50. The control fluid is jetted approximately at right angles towards the fuel flowing into the fluidic valve 62 from the inlet 64. This has the effect of diverting the inlet flow away from the first port 72a so that it flows through the chamber 74 towards the first outlet 66. The control fluid is mixed into the main inlet flow. Thus the inlet 64 is fluidically coupled to the first outlet 66 by the flow of control fluid into the first port 72a of the control flow inlet 68. Fuel from the mains manifold 46 is therefore delivered to the pilot nozzles 56 through the fluidic valve 62. Advantageously flow can be maintained in the mains manifold 46, the mains supply pipe 48 and the pigtails which couple each injector 42 to the mains manifold 46. Such flow reduces the temperature of the components and minimises the risk of coking in the pipes, and consequent blockages or failures in the mains stage of combustion. Accurate metering may be maintained by diverting a portion of the metered flow from the pilot supply pipe 52 into the mains supply pipe 48, close to the fuel metering valve 34. All the diverted flow is advantageously recombined with the bulk of the pilot flow due to the action of the fluidic valve 62.

FIG. 6 shows the fluidic valve 62 in a second configuration in which the control fluid is delivered through the second port 72b of the control flow inlet 68. There is no physical change in the structure of the fluidic valve 62 which operates without moving parts. The control fluid may be provided from the mains manifold 46. The control fluid is jetted approximately at right angles towards the fuel flowing into the fluidic valve 62 from the inlet 64. This has the effect of diverting the inlet flow away from the second port 72b so that it flows through the chamber 74 away from the first outlet 66, towards the second outlet 70. The control fluid is mixed into the main inlet flow. Thus the inlet 64 is fluidically decoupled from the first outlet 66 and fluidically coupled to the second outlet 70 by the flow of control fluid into the second port 72b of the control flow inlet 68. Fuel from the mains manifold 46 is therefore delivered to the mains nozzles 54 through the fluidic valve 62.

Advantageously the fuel may be accurately metered between the pilot and mains stages. When the fluidic valve 62 is in the second configuration all of the fuel that passes through the mains manifold 46 is delivered to the combustor 16 through the mains nozzles 54 and all of the fuel that passes through the pilot manifold 50 is delivered to the combustor 16 through the pilot nozzles 56. Where a connection has been provided from the pilot supply pipe 52 to the mains supply pipe 48 this may be closed when the fluidic valve 62 is controlled to its second configuration, with the second port 72b of the control flow inlet 68 supplied with control fluid. The fuel metering valve 34 can thus be configured to deliver the proportions of fuel to the mains and pilot manifolds 46, 50 which it is desired to deliver to the combustor 16 through the mains and pilot nozzles 54, 56. Alternatively the connection from the pilot supply pipe 52 to the mains supply pipe 48 may be left open and the fuel metering be scheduled to take account of the diversion of some of the fuel intended for the pilot nozzles 56 which will instead be delivered to the mains nozzles 54.

The fluidic valve 62 has no moving parts. Instead its operation is governed by the flow of control fluid through the control flow inlet 68. Advantageously there are no moving parts to jam or fail. This is particularly beneficial because the fluidic valve 62 is situated in a very hot part of an engine 10, close to the combustor 16, and so is subject to high temperatures which accelerate component failure.

FIG. 7 shows part of the fuel flow system 28 with a single fuel nozzle 44 housed in one of the injectors 42. It also shows part of the fuel manifold 38. The fluidic valve 62 is shown and has its inlet 64 coupled to the fuel manifold 38 and its first outlet 66 coupled to the fuel nozzle 44. A first control fluid duct 76 is coupled to the first port 72a of the control flow inlet 68 to selectively deliver control fluid to the fluidic valve 62. Similarly a second control fluid duct 78 is coupled to the second port 72b of the control flow inlet 68 to selectively deliver control fluid to the fluidic valve 62 when the first control fluid duct 76 is not delivering control fluid. The control fluid, in addition to the main fuel to be burnt in the combustor 16, is supplied by the fuel pump 32.

Between the fuel pump 32 and the first and second control fluid ducts 76, 78 is a splitter valve 80. The splitter valve 80 has an inlet port 82 which is fed from the fuel pump 32. The inlet port 82 is open to a valve chamber 84. The valve chamber 84 is housed in a valve body 86 which translates, vertically as shown, in order to fluidically couple or decouple the valve chamber 84 to any one or more outlet ports. A first outlet port 88 is coupled to the first control fluid duct 76. A second outlet port 90 is coupled to the second control fluid duct 78. The valve body 86 is configured to translate so that the valve chamber 84 is fluidically coupled either to the first outlet port 88 or to the second outlet port 90 or to neither of the outlet ports 88, 90. The splitter valve 80 may be controlled by a controller 92 which generates control signals as shown by the dotted line. The controller 92 may be configured to generate control signals which control the pressure of the upper and lower chambers of the splitter valve 80 to translate the valve body 86.

In a first mode of operation the splitter valve 80 is controlled to deliver control fluid through the first control fluid duct 76 to the first port 72a of the control flow inlet 68 of the fluidic valve 62. The flow from the fuel manifold 38 passes into the fluidic valve 62 through the inlet 64 and is diverted to exit the fluidic valve 62 through the first outlet 66 and to pass to the fuel nozzle 44.

In a second mode of operation the splitter valve 80 is controlled to deliver control fluid through the second control fluid duct 78 to the second port 72b of the control flow inlet 68 of the fluidic valve 62. This causes the inlet flow from the fuel manifold 38 to be diverted away from the first outlet 66 so that the fuel nozzle 44 is decoupled from the fuel manifold 38. Optionally the fluidic valve 62 may include a second outlet 70 to which the inlet flow is directed in the second mode of operation. The second outlet 70 may be coupled, for example, to the fuel manifold 38 so that the fuel is recirculated. Alternatively the second outlet 70 may be coupled to an upstream component of the fuel flow system 28 such as the fuel pumps 32 or fuel tanks 30.

Thus the fluidic valve 62 acts as a switch in the single manifold fuel flow system 28 illustrated in FIG. 7.

FIG. 8 is similar to FIG. 7 but shows part of the two-stage fuel flow system 28. It shows one of the injectors 42 with a mains nozzle 54 and a pilot nozzle 56, part of the mains manifold 46 and part of the pilot manifold 50. The fluidic valve 62 is shown with its inlet 64 coupled to the mains manifold 46, its first outlet 66 coupled to the pilot nozzle 56 and its second outlet 70 coupled to the mains nozzle 54. A first control fluid duct 76 is coupled to the first port 72a of the control flow inlet 68 to selectively deliver control fluid to the fluidic valve 62. Similarly the second control fluid duct 78 is coupled to the second port 72b of the control flow inlet 68 to selectively deliver control fluid to the fluidic valve 62 when the first control fluid duct 76 is not delivering control fluid. The control fluid, in addition to the main fuel to be burnt in the combustor 16, is supplied by the fuel pump 32.

Between the fuel pump 32 and the first and second control fluid ducts 76, 78 is a splitter valve 80. The splitter valve 80 has an inlet port 82 which is fed from the fuel pump 32. The inlet port 82 is open to a valve chamber 84. The valve chamber 84 is housed in a valve body 86 which translates, vertically as shown, in order to fluidically couple or decouple the valve chamber 84 to any one or more outlet ports. A first outlet port 88 is coupled to the first control fluid duct 76. A second outlet port 90 is coupled to the second control fluid duct 78. The valve body 86 is configured to translate so that the valve chamber 84 is fluidically coupled either to the first outlet port 88 or to the second outlet port 90 or to neither of the outlet ports 88, 90. The splitter valve 80 may be controlled by a controller 92 which generates control signals as shown by the dotted line. The controller 92 may be configured to generate control signals which control the pressure of the upper and lower chambers of the splitter valve 80 to translate the valve body 86.

The splitter valve 80 may also be configured to couple the valve chamber 84 to the pilot supply pipe 52, or to both the pilot supply pipe 52 and the mains supply pipe 48. Advantageously the splitter valve 80 therefore has two functions: firstly to deliver the requisite proportion of the fuel flow to the pilot nozzles 54, via the pilot manifold 50, or to the pilot and mains nozzles 54, 56, via the pilot and mains manifolds 50, 46 respectively; secondly to supply control fluid to the first or second port 72a, 72b of the control flow inlet 68 of the fluidic valve 62 to shut off or open the fluid connection to the mains nozzles 54.

Advantageously in pilot only mode around 90% of the pilot mass flow may be directed through the pilot manifold 50 for direct delivery to the pilot nozzles 56. The remainder of the required mass flow, around 10%, is directed into the mains manifold 46 and passes through the fluidic valves 62 to maintain manifold priming and flow in the pipes to prevent coking. The 10% fuel mass flow is then delivered to the pilot nozzles 56 by action of the fluidic valves 62 so that 100% of the required mass flow is delivered to the pilot nozzles 56. Advantageously it is not necessary to oversupply fuel in order to maintain mains manifold 46 priming, to cool the mains components or to maintain flow to prevent coking. As will be apparent, alternative pilot:mains manifold splits than 90%:10% are also feasible.

Advantageously in pilot+mains mode 100% of the required pilot flow is delivered through the pilot manifold 50 to the pilot nozzles 56 and 100% of the required mains flow is delivered through the mains manifold 46 to the mains nozzles 54. The fluidic valves 62 act to prevent any fuel migrating from the mains manifold 46 to the pilot nozzles 56. Advantageously the fuel split is accurate.

An alternative fluidic valve 62 is shown in FIG. 9. The fluidic valve 62 illustrated is a fluidic diverter. In common with the linear proportional amplifier shown in FIG. 5 there is an inlet 64, a first outlet 66, a second outlet 70 and a control fluid inlet 68 comprising first and second ports 72a, 72b. However, there is no chamber 74. Instead the fuel flow is passed directly from the inlet 64 to the first or second outlet 66, 70 dependent on whether the flow of control fluid into the fluidic valve 62 is supplied through the first port 72a or the second port 72b. The first and second ports 72a, 72b each have a diameter which is up to the diameter of the inlet 64, for example between ¾ of the diameter and the full diameter. The first port 72a is defined by an inlet-side wall and an outlet-side wall, on the left and right respectively as drawn. There is a step offset between the vertical height, as drawn, of the inlet-side and outlet-side walls which may be approximately half the diameter of the inlet 64. The second port 72b is a mirror image of the first port 72b. Thus the vertical distance between the ends of the inlet-side walls of the first and second ports 72a, 72b is twice the vertical distance between the ends of the outlet-side walls. Other relative sizing is also possible as understood by the person skilled in the art.

A further alternative fluidic valve 62 is shown in FIG. 10. The fluidic valve 62 illustrated is a vortex valve or vortex amplifier. The vortex valve 62 includes an inlet 64 and a first outlet 66 with a chamber 74 between them. The chamber 74 is circular or annular with the first outlet 66 extending perpendicularly from the plane of the chamber 74 along the axis of symmetry of the chamber 74. Thus the first outlet 66 extends into or out of the page as drawn. The inlet 64 is in the plane of the chamber 74 and is radially aligned so that fuel supplied through the inlet 64 is directed straight towards the first outlet 66 and has the shortest path to travel across the chamber 74.

The control fluid inlet 68 comprises only one port 72, in contrast to the linear proportional amplifier or fluidic diverter. Thus control fluid is either supplied to the fluidic valve 62 or is blocked from entering the fluidic valve 62, for example by an upstream valve such as the splitter valve 80. The control fluid inlet 68 lies in the plane of the chamber 74 close to the inlet 64 and is mutually perpendicular to the inlet 64. The control fluid inlet 68 thus supplies control fluid tangentially into the chamber 74. The control fluid is directed across the inlet flow. This causes the inlet flow from the inlet 64 to curve around the chamber 74 and to form a spiral instead of traversing the chamber 74. The fluid flow spirals towards the first outlet 66 but reaches the first outlet 66 approximately at a tangent to its periphery. Therefore little of the fluid passes into the first outlet 66 for delivery to the main nozzles 54. The amount of inlet flow which is delivered through the first outlet 66 can be controlled by the relative mass flow of the flow through the inlet 64 and the control fluid inlet 68. In a typical vortex valve the ratio of flow into the first outlet 66 may be approximately 10:1 between the first and second configurations, e.g. with the control flow inlet 68 closed or delivering control fluid. However ratios of up to 30:1 are also possible meaning that there is a negligible flow into the first outlet 66 when the control fluid inlet 68 is supplying fluid into the chamber 74.

A further alternative fluidic valve 62 is shown in FIG. 11. The fluidic valve 62 uses acoustic modulation instead of a control flow. The inlet 64, first outlet 66 and optional second outlet 70 are similar to the fluidic diverter shown in FIG. 9. The control flow inlet 68 is differently configured. Instead of the first and second ports 72a, 72b there are first and second acoustic modulators 100a, 100b. For example each acoustic modulator 100a, 100b may be a piezoelectric modulator. A piezoelectric modulator oscillates rapidly in response to an electric impulse signal. The oscillation is typically very small. Nonetheless, the oscillation of each piezoelectric modulator 100a, 100b is sufficient to divert the flow of fluid from the inlet 64 to one or other of the outlets 66, 70.

The first piezoelectric modulator 100a is arranged to divert the inlet flow towards the first outlet 66 by ‘pushing’ the inlet flow away from the first modulator 100a. The second piezoelectric modulator 100b is arranged to divert the inlet flow towards the second outlet 70 by ‘pushing’ the inlet flow away from the second modulator 100b. Certain frequencies are particularly effective for latching the inlet flow to one or other output 66, 70, the specific frequencies being dependent on the dimensions of the fluidic valve 62 and the shear layer dynamics of the inlet jet.

The first and second acoustic modulators 100a, 100b may be magnetohydrodynamic generators such as plasma generators instead of piezoelectric modulators. Plasma generators work by applying a voltage through a dielectric to form plasma and thereby ionise passing fluid. Alternatively the plasma generator may comprise a pair of terminals across which a spark can be generated to superheat the fluid to plasma. The formation of the plasma causes a pressure wave to act on the inlet flow to divert it to the first outlet 66 or second outlet 70. Other magnetohydrodynamic generators are also contemplated within the scope of the described fluidic valve 62.

FIG. 12 and FIG. 13 show a further fluidic valve 62 in first and second operating configurations. The fluidic valve 62 is similar to that shown in FIG. 9 it has an inlet 64, a first outlet 66 and a second outlet 70. However, the control flow inlet 68 has only one port 72. In addition there is a pipe 102, one end of which is coupled opposite where the control flow inlet 68 meets the inlet 64. Thus it is positioned where the second port 72b is provided in the fluidic diverter shown in FIG. 9. The other end of the pipe 102 is positioned part of the way along the tube to the first outlet 66.

In the first operating configuration, FIG. 12, a strong flow of control fluid is delivered through the port 72 of the control flow inlet 68. The flow alters the momentum flux of the inlet flow and is sufficiently strong to ‘push’ the flow from the inlet 64. The flow from the control flow inlet 68 is entrained into the inlet flow. The effect of the control jet ‘pushing’ the inlet flow towards the first outlet 66 diverts the inlet flow to exit the fluidic valve 62 through the first outlet 66. Due to the pressure differential across the pipe 102 a proportion of the flow towards the first outlet 66 is recirculated through the pipe 102, anticlockwise as illustrated, and re-entrained into the flow at the junction of the control flow inlet 68 and the inlet 64, The fluidic valve 62 is maintained in the first operating configuration by active delivery of control flow through the port 72.

In the second operating configuration, FIG. 13, the control fluid flow is removed. The momentum flux of the flow from the inlet 64 therefore directs the flow towards the second outlet 70 which is its default direction. As the control flow is switched off the recirculating flow through pipe 102 provides a jet towards the inlet flow 64 which assists in rapidly switching the inlet flow direction to the second outlet 70. The flow from inlet 64 to the second outlet 70 is the default, passive, operating configuration as it is maintained without application of a control flow, relying on the Coanda effect alone.

FIG. 14 shows three of a plurality of injectors 42 in a fuel flow system 28. Each injector 42 houses a mains nozzle 54 and a pilot nozzle 56 as in previous figures. The pilot nozzle 56 is supplied with fuel from the pilot manifold 50. The mains nozzle 54 is selectively supplied with fuel from the mains manifold 46 during pilot+mains operation. During pilot only operation the fluidic valve 62 is operated to divert fuel from the mains manifold 46 away from the mains nozzle 54 and to deliver it to the pilot nozzle 56 instead. Each fluidic valve 62 is coupled to a first control fluid duct 76 and a second control fluid duct 78. Where the fluidic valve 62 has only one control flow inlet 68, such as the vortex valve illustrated in FIG. 10, the second control fluid ducts 78 are omitted.

A control fluid manifold 94 is provided which is fluidically coupled to each of the first control fluid ducts 76. The control fluid manifold delivers control fluid to each fluidic valve 62. The control fluid manifold 94 may also be fluidically coupled to each of the second control fluid ducts 78, where these are provided, in order to deliver control fluid to the fluidic valves 62 to switch the operation between pilot only and pilot+mains operation.

FIG. 15 and FIG. 16 show a fluidic valve 62 formed as a cascade in, respectively, first and second configurations. The cascade comprises a first fluidic valve 96 and a second fluidic valve 98. The first and second fluidic valves 96, 98 are each as described with respect to FIG. 5 and FIG. 6. Thus each has an inlet 64 coupled to the fuel manifold 38, mains manifold 46; a first outlet 66 coupled to the fuel nozzle 44, pilot nozzle 56; a second outlet 70; and a control flow inlet 68 comprising a first port 72a and a second port 72b. The cascade is arranged so that the second output 70 of the first fluidic valve 96 is coupled to the first port 72a of the control fluid inlet 68 of the second fluidic valve 98. This means that in the first configuration, shown in FIG. 15 and corresponding to pilot only operation of the combustor 16, fuel is supplied to the inlets 64 of each fluidic valve 96. 98. Control fluid is supplied to the first port 72a of each fluidic valve 96, 98 which directs the inlet flow through the chamber 74 and out of the first outlet 66. However, in the second configuration, shown in FIG. 16 and corresponding to pilot+mains operation of the combustor 16, the control fluid is supplied to the second port 72b of the first fluidic valve 96. This causes the inlet flow to be diverted towards the second outlet 70. The second outlet 70 of the first fluidic valve 96 is coupled to the second port 72b of the control flow inlet 68 of the second fluidic valve 98. Hence the flow through the second outlet 70 of the first fluidic valve 96 becomes the control fluid entering the second fluidic valve 98 which diverts the inlet flow into the second fluidic valve 98 to exit through the second outlet 70. The second outlet 70 of the second fluidic valve 98 is coupled to the mains nozzle 54. Further fluidic valves may be added to the cascade in the same manner so that the second outlet 70 of one fluidic valve is coupled to the second control flow port 72b of the next fluidic valve. Advantageously by cascading two or more fluidic valves 62 in series it is possible to amplify the volume of inlet flow which can be diverted by the fluidic valves 62. Advantageously this increases the range of mains manifold 46 flow rates which can be switched by the fluidic valves 62. For example, mains flow may be in the range 30 pounds per hour (0.004 kilograms per second) to 1400 pounds per hour (0.176 kilograms per second).

In an alternative cascade arrangement the first control flow port 72a of the second fluidic valve 98 is grounded and the second fluidic valve 98 is configured to bias the inlet flow to the first outlet 66. Effectively the second fluidic valve 98 therefore behaves like a fluidic valve 62 with only one outlet 66. In the first configuration the mains manifold 46 supplies fuel into the inlet 64 of the first fluidic valve 96 which is controlled by control fluid flow into the first port 72a to expel the inlet flow through the first outlet 66 to deliver it to the pilot nozzle 56. The mains manifold 46 also supplies fuel into the inlet 64 of the second fluidic valve 98 which is geometrically biased to expel the flow through the first outlet 66 to also deliver it to the pilot nozzle 56. In the second configuration the mains manifold delivers fuel to the inlet 64 of the first fluidic valve 96 which is controlled by the control fluid flow into the second port 72b to deliver the fuel through the second outlet 70 to enter the second fluidic valve 98 through the second (only) control flow port 72b. This diverts the inlet flow from the mains manifold 46 to exit the second fluidic valve 98 through the second outlet 70 and thence to supply the mains nozzle 54.

The second fluidic valve 98 may be positioned in any convenient location relative to the first fluidic valve 96. For example, the first and second fluidic valves 96, 98 may be radially, circumferentially, axially, tangentially, vertically or laterally adjacent. The first and second fluidic valves 96, 98 may also be offset from each other in any of the radial, circumferential, axial, tangential, vertical or lateral directions.

The splitter valve 80 described with respect to FIG. 7 and FIG. 8 may be omitted in favour of control signals. The control signals are configured to open the first or second port 72a, 72b of the control inlet 68 of the fluidic valve 62 to a source of control fluid.

The described fuel flow system is particularly applicable for a gas turbine engine 10. Such a gas turbine engine 10 may be used to power an aircraft, a marine vessel or an industrial plant.

It will be understood that the invention is not limited to the embodiments above-described and various modifications and improvements can be made without departing from the concepts described herein. Except where mutually exclusive, any of the features may be employed separately or in combination with any other features and the disclosure extends to and includes all combinations and sub-combinations of one or more features described herein.

1-21. (canceled)

22. A fuel flow system comprising:
a mains fuel stage;
a pilot fuel stage;
a mains fuel manifold;
a pilot fuel nozzle; and
a fluidic valve having an inlet, a first outlet and a control flow inlet; the inlet coupled to the mains fuel manifold; the first outlet coupled to the pilot fuel nozzle; and the control flow inlet coupled to a source of control fuel; the fluidic valve configured to selectively couple the inlet to the first outlet dependent on the control flow into the control flow inlet.

23. A fuel flow system as claimed in claim 22 further comprising a plurality of pilot fuel nozzles, the first outlet of the fluidic valve coupled to each of the plurality of pilot fuel nozzles.

24. A fuel flow system as claimed in claim 22 further comprising a plurality of pilot fuel nozzles and a plurality of fluidic valves, the first outlet of each fluidic valve coupled to one or more of the plurality of pilot fuel nozzles.

25. A fuel flow system as claimed in claim 22 further comprising two or more fluidic valves, the first output of one of the fluidic valves coupled to the flow control inlet of a second of the fluidic valves.

26. A fuel flow system as claimed in claim 22 wherein the fluidic valve comprises any one of: a fluidic diverter; a linear proportional amplifier; a vortex amplifier; a turbulence amplifier.

27. A fuel flow system as claimed in claim 22 further comprising fuel split apparatus arranged to selectively couple the mains fuel manifold to a fuel source.

28. A fuel flow system as claimed in claim 27 wherein the fuel split apparatus comprises a splitter valve.

29. A fuel flow system as claimed in claim 27 wherein the fuel split apparatus comprises a control valve having two outputs.

30. A fuel flow system as claimed in claim 22 wherein the source of control fuel comprises the mains fuel manifold.

31. A fuel flow system as claimed in claim 22 further comprising a pilot manifold coupled to the pilot fuel nozzle.

32. A fuel flow system as claimed in claim 31 further comprising fuel split apparatus arranged to selectively couple the pilot manifold to the fuel source.

33. A fuel flow system as claimed in claim 31 wherein the mains manifold and the pilot manifold are each coupled to the fuel source.

34. A fuel flow system as claimed in claim 31 wherein the mains manifold is selectively coupled to the pilot manifold when the fluidic valve inlet is coupled to the first outlet.

35. A fuel flow system as claimed in claim 22 further comprising a mains nozzle selectively coupled to the mains manifold.

36. A fuel flow system as claimed in claim 35 wherein the fluidic valve comprises a second outlet coupled to the mains nozzle.

37. A gas turbine engine comprising a fuel flow system as claimed in claim 22.

38. A fuel flow system comprising:
a mains fuel stage;
a pilot fuel stage;
a mains fuel manifold;
a pilot fuel nozzle; and
a fluidic valve having an inlet, a first outlet and a control modulator; the inlet coupled to the mains fuel manifold; the first outlet coupled to the pilot fuel nozzle; the fluidic valve configured to selectively couple the inlet to the first outlet dependent on the control signal in the control modulator.

39. A fuel flow system as claimed in claim 38 wherein the control modulator comprises an acoustic modulator.

40. A fuel flow system as claimed in claim 38 wherein the acoustic modulator comprises any one of: a piezoelectric modulator; a magnetohydrodynamic generator; a plasma generator.

41. A fuel flow system as claimed in claim 38 further comprises two control modulators, each control modulator comprises an acoustic modulator.
